(19) United States
(12) Patent Application Publication
(10) Pub. No.: US 2021/0190076 A1
(43) Pub. Date: Jun. 24, 2021

(54) CONTROLLABLE COOLANT PUMP WITH A FILTER DISC, FILTER DISC, AND THE PRODUCTION THEREOF

(71) Applicant: NIDEC GPM GmbH, Auengrund OT Merbelsrod (DE)

(72) Inventor: Toni STEINER, Bachfeld (DE)

(21) Appl. No.: 17/053,374

(22) PCT Filed: Mar. 7, 2019
(86) PCT No.: PCT/EP2019/055716

§ 371 Date: Nov. 6, 2020

(30) Foreign Application Priority Data
Jun. 19, 2018 (DE) 10 2018 114 705.8

(51) Int. Cl. F04D 15/00; F04D 13/02; F04D 29/02; F04D 29/043; F01P 5/12

(52) U.S. Cl. CPC F04D 15/0038; F04D 13/02; F01P 5/12; F04D 29/043; F04D 29/026

(57) ABSTRACT

In an adjustable coolant pump for delivering a coolant for a combustion engine, a delivery flow of the coolant can be limited by a regulating slide which is actuated by a hydraulic actuator in a hydraulic control loop, wherein the hydraulic control loop is supplied with the coolant from the delivery flow, and includes an axial piston pump and a proportional valve for generation and adjustment of a pressure on the hydraulic actuator. A sliding shoe, which is arranged on an intake side of the axial piston pump, surrounds an inlet of the axial piston pump, and a filter disk for filtering the coolant prior to entry into the hydraulic control loop is in sliding contact with the sliding shoe so that coolant from the pump chamber is sucked into the axial piston pump through the filter disk and the sliding shoe, while a rotational movement of the filter disk is transformed into a stroke movement of the axial piston pump. The filter disk consists of a ceramic material.

### FIELD OF THE INVENTION

The present invention relates to an adjustable coolant pump with an improved filter disk, to the improved filter disk for a corresponding adjustable coolant pump and to a method for producing the improved filter disk.

### BACKGROUND OF THE INVENTION

The prior art discloses mechanically driven coolant pumps in which, in spite of a dependency upon the speed of a combustion engine, an effective delivery output can be switched on or switched off in a restricted manner by a belt drive. Therefore, in the case of a mechanical pump drive, functions such as coolant standstill during a cold start phase of a combustion engine or the like can be achieved.

During the course of this development, a coolant pump type with an electro-hydraulically controlled regulating slide for setting the volume flow has proved to be particularly reliable. A pump with this construction, which has become known by the term ECF (electro-hydraulic controlled flow) pump, is disclosed e.g. in the German patent specification DE 10 2008 026 218 B4 of the applicant.

In such an ECF coolant pump, a cylindrical regulating slide is displaced by means of a hydraulic actuator over a peripheral region of an impeller of the coolant pump. The hydraulic pressure of the actuator is in this case not produced by a closed circuit with a hydraulic oil but rather is applied via a branched-off side-flow of the coolant which serves as a hydraulic control loop.

Such a coolant-based hydraulic system requires no additional dynamic sealing points with respect to the atmosphere or to the delivery flow. However, it must be ensured that no particulate impurities in the coolant from the delivery flow can enter the hydraulic control loop and impair the function of an axial piston pump, provided for the hydraulic control loop, of a proportional valve or of the hydraulic actuator.

### BRIEF SUMMARY OF THE INVENTION

Thus in case of the ECF pump type, a filter disk made of stainless steel is provided, through which the coolant is filtered before it is sucked in by the axial piston pump of the hydraulic control loop. The filter disk is arranged on a rear face of the impeller in the pump chamber and rotates jointly with this or with the pump shaft. A sliding shoe made of stainless steel, which slides on the rotating filter disk and transfers a driving movement to the axial piston pump, forms a seal between the filter disk and an intake side of the axial piston pump.

The filter disk is a ring formed from sheet metal with a perforated screening section and has a thickness of 1 mm or less. The filter disk is fastened to a receiver on the rear face of the impeller. An integral substructure of the receiver on the impeller for the filter disk can have manufacturing tolerances or fitting tolerances during mounting of the filter disk. These tolerances bring about a local distortion of the thin filter disk, i.e. deviations with respect to an absolutely planar sliding contact surface of a track of the filter disk, along which an annular sliding contact surface of the bell-shaped sliding shoe slides in a sealing manner.

Even slight deviations at the dynamic sealing gap between the annular sliding contact surface of the bell-shaped sliding shoe and the sliding contact surface of the filter disk lead to leakage flows on the intake side of the axial piston pump of the hydraulic control loop. In addition, a distortion of the filter disk can lead to uneven wearing of the annular sliding contact surface of the sliding shoe, whereby permanent leakage occurs at the dynamic sealing gap with respect to the filter disk.

By means of leakage flows, e.g. particles of dirt, in particular dirt particles which have settled on the running surface, can enter the hydraulic control loop. Furthermore, by means of leakage flows at the hydraulic control loop, adjusting behaviour during starting and stopping of the coolant pump is impaired.

An object of the invention is to improve dynamic sealing on the intake side of the axial piston pump at the sliding contact between the sliding shoe and the thin, screen-like filter disk. Furthermore, a secondary aspect is to ensure such an improvement in sealing even in the case of high numbers of parts without significantly increased expenditure.

The object is achieved by the features of the coolant pump according to claim 1, the filter disk according to claim 4 and the production method according to claim 6.

The adjustable coolant pump according to the invention and a corresponding filter disk according to the invention are characterized in that the filter disk consists of a ceramic material.

The use of a ceramic material instead of a stainless steel for the filter disk provides a number of advantages.

The filter disk made of ceramic material has a high level of stiffness. In this way, in the case of a comparable dimension in a thickness direction in comparison to a filter disk made of stainless steel, a local distortion at the filter disk during manufacture of the coolant pump can be reliably prevented. Therefore, in accordance with the invention, no distortion owing to a fitting tolerance on a substructure or a contact surface of the receiver for the filter disk on the impeller occurs at the filter disk made of ceramic material. Similarly, distortion owing to an application of force during fitting or fastening of the filter disk on the impeller is prevented. The high level of stiffness of the filter disk made of ceramic material thus ensures, in accordance with the invention, tension-free mounting and dimensionally stable planarity of the running surface of the filter disk. Consequently, dynamic sealing of the bell-shaped sliding shoe along the filter disk is qualitatively improved.

Owing to the improved dynamic sealing of the bell-shaped sliding shoe along the filter disk, leakage flows are reduced and entry of dirt particles into the hydraulic control loop, including those which have settled on the filter disk, can be effectively prevented. Furthermore, by the reduction of leakage flows, the adjusting behaviour during starting and stopping of the coolant pump is improved.

At the same time, in accordance with the invention, the production of a coolant pump with improved corresponding sealing is rendered possible in a simple manner, i.e. in particular without increased outlay with respect to maintaining dimensional stability when producing a fitting member, during mounting or post-monitoring by means of measuring technology. Therefore, it is possible to achieve production of high numbers of parts without correspondingly higher outlay, which is dependent on numbers of parts, in order to ensure the quality of the improved dimensional stability after the mounting process. Consequently, dynamic sealing of the bell-shaped sliding shoe along the filter disk is also quantitatively ensured.

Furthermore, the filter disk made of ceramic material can also be produced less expensively as a filter disk made of a suitable stainless steel alloy which ensures a desired level of wear resistance. Therefore, in accordance with the invention, production costs for the filter disk and for the corresponding coolant pump are reduced.

In the prior art, and in another technical context in relation to friction pairings, it is known that ceramic materials have a higher level of abrasion resistance than metals or synthetic materials, whereby a higher level of wear resistance can be achieved on friction surfaces of a drive mechanism. This aspect is disclosed in US 2013/0118346 A1 which proposes coating an inclined plate, with a wedge-shaped longitudinal cross-section, on a rotational piston pump with a ceramic or producing it entirely from this ceramic.

However, in such a case, a different effect for a different purpose is achieved compared to the effect in accordance with the invention for improving a dynamic sealing gap of a specific arrangement described above.

In the known technical context, the use of a ceramic serves to improve a coefficient of friction or wear resistance of a friction surface on a relatively solid drive component. The invention is a departure from this because the alternatives of a solid ceramic body or of a thin coating on a solid body lead away from the formation of thin delicate pump components from a ceramic if these are subjected to drive loading. These conventional alternatives take into consideration the relatively brittle material property of ceramics.

The production method in accordance with the invention is characterised in that a filter structure of the filter disk is cut or laser-drilled by a laser with a light pulse duration set in the femtosecond range, a multitude of openings with an average diameter of 80-300 μm from the ceramic material of a circular disk.

Therefore, a completely automation-free process for producing the filter disk from ceramic material is provided, which permits precise and rapid preparation of the filter structure.

Advantageous developments of the invention are provided in the dependent claims.

According to one aspect of the invention, the sliding shoe can also consist of the ceramic material.

Therefore, a friction pairing with the same material properties, in particular an identical parameter for the hardness of the material, is provided. In this case, non-uniform wearing between the annular sliding contact surface of the sliding shoe and the sliding contact surface of the filter disk can be additionally prevented.

According to one aspect of the invention, the ceramic material can consist of silicon nitride (Si₃N₄) or contain same as a main component.

In the present usage, silicon nitride is for the first time provided as a ceramic for filter elements with a dynamic sealing surface. Within the usage in accordance with the invention it has transpired that silicon nitride has particularly suitable material properties in relation to stiffness, coefficient of friction, hardness as well as availability and material and processing costs.

According to one aspect of the invention, the multitude of openings can be produced with circular diameters of the same or different sizes using laser drilling. This filter structure permits simplified and more rapid precision processing of the ceramic by means of a laser drilling process.

According to one aspect of the invention, the multitude of openings can have a uniform diameter of 100 μm. This diameter range has proved to be particularly effective in the usage in accordance with the invention in order to carry out filtering to avoid the hydraulic control loop being impaired by particles of dirt.

According to one aspect of the invention, mechanical smoothing of a surface of the filter structure on the circular disk can follow laser-assisted cutting or laser-drilling of the filter structure. In this way, deburring of a material discharge at the openings of the filter structure can be ensured.

### BRIEF DESCRIPTION OF THE FIGURES

The invention will be explained in more detail hereinunder by means of an exemplified embodiment and with the aid of the Figures in which:

FIG. 1 shows a cross-sectional view of the whole coolant pump, in which the filter disk according to the present invention is arranged;

FIG. 2 shows a cross-sectional view of an inner region of the coolant pump, in which the axial piston pump is arranged on the filter disk according to the present invention.

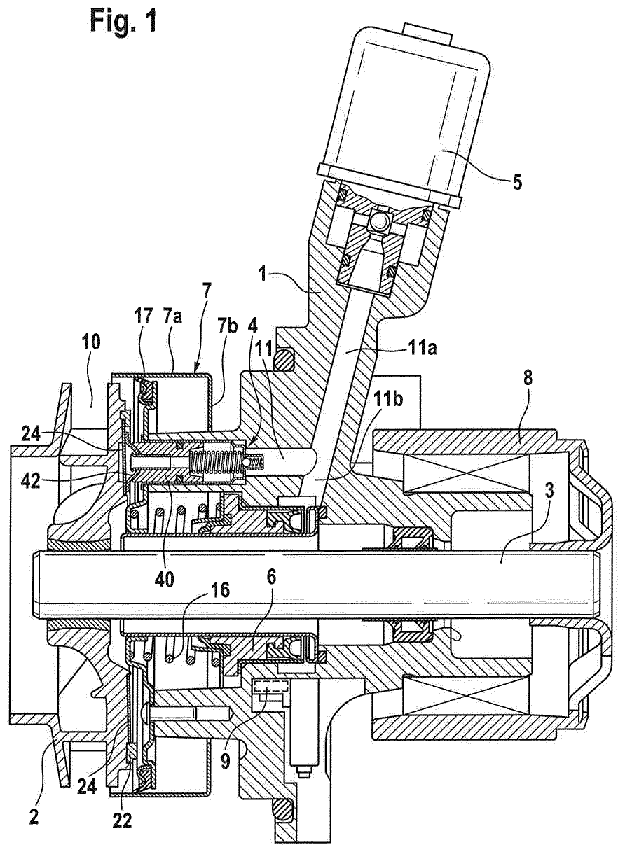

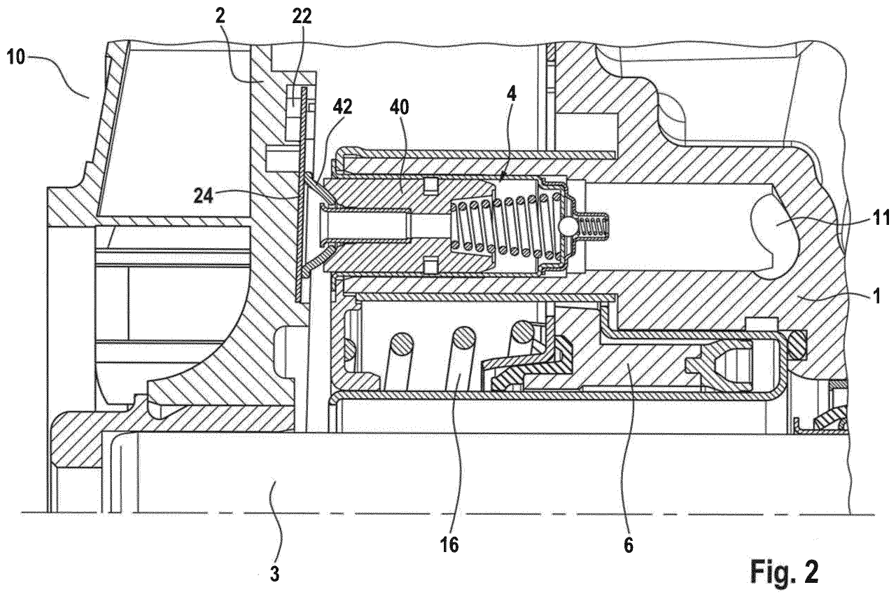

A structure of the coolant pump is described hereinunder with reference to FIGS. 1 and 2.

### DETAILED DESCRIPTION OF THE INVENTION

As shown in FIG. 1, the coolant pump comprises a pump housing 1 and a pump shaft 3 rotatably mounted therein, having a belt pulley 8 which is driven by means of a belt drive of a combustion engine (not illustrated). At a free end of the pump shaft 3, an impeller 2 is arranged for conjoint rotation, this impeller being incorporated within a pump chamber 10 in a flow region of a coolant circuit of the combustion engine in order to effect a volume flow of the coolant. The coolant is sucked in through an axial inlet (not illustrated) of the pump chamber 10 into a central region of the impeller 2 and is ejected through a radial outlet (not illustrated) of the pump chamber 10 which is opposite a peripheral region of the impeller 2.

The flow region of the impeller 2 can be covered in a variable manner by a regulating slide 7 with a cylindrical section 7a, arranged coaxially to the pump shaft 3, and with a rear wall section 7b along an adjustment path extending parallel to the pump shaft 3. A sealing lip 17 extends between the inner peripheral wall of the cylindrical section 7a of the regulating slide 7 and a rear wall of the pump chamber 10. In FIG. 1, the regulating slide 7 is in an “open position” in which the flow region of the impeller 2 is not covered.

An axial piston pump 4, to be described later, is arranged behind the pump chamber 10 and sucks in coolant from a flow region on the rear face of the impeller 2. In a hydraulic control loop 11, the axial piston pump 4 provides a pressure for hydraulic adjustment of the regulating slide 7 by means of the sucked-in coolant. The hydraulic control loop 11 branches into two branches 11a and 11b. One branch 11a of the hydraulic control loop 11 leads on the one hand to an electromagnetic proportional valve 5 and back into the delivered coolant flow. The other branch 11b of the hydraulic control loop 11 leads to a tubular piston 6 which is arranged coaxially to the pump shaft 3 and adopts the function of a hydraulic actuator along the adjustment path of the regulating slide 7.

A return spring 16 acts upon the tubular piston 6 in the opposite direction to the pressure of the hydraulic control loop 11, i.e. away from the impeller 2. The tubular piston 6 is connected to the regulating slide 7 and displaces same as the pressure in the hydraulic control loop 11 increases in the direction of the impeller 2.

The electromagnetic proportional valve 5 is opened without the supply of an actuating current so that the coolant sucked in by the axial piston pump 4 flows back into the delivered coolant flow under substantially no pressure via the branch 11a of the hydraulic control loop 11 through the proportional valve 5. Therefore, no pressure builds up in the branch 11b of the hydraulic control loop 11, and the tubular piston 11 remains under the influence of the return spring 16 in a non-actuated basic position. The regulating slide 7, which is connected to the tubular piston 6, is thus held in the “open position” as shown in FIG. 1.

When the regulating slide is in the “open position” a maximum delivered volume flow, without shielding of a flow-effective region of the impeller 2, is produced by the regulating slide 7 without consideration of the pump rotation speed. This state also constitutes a fail-safe mode so that in the event of a failure of a flow supply or of a defect in the actuation, i.e. an electromagnetic proportional valve 5 being without power, a maximum volume flow and the greatest possible discharge of heat at the combustion engine are automatically ensured.

When the electromagnetic proportional valve 5 is temporarily closed by a time-controlled supply of an actuating current, the coolant ejected by the axial piston pump 4 cannot flow back into the volume flow via the branch 11a of the hydraulic control loop 11. The pressure applied by the axial piston pump 4 in the hydraulic control loop 11 spreads out from the backing-up at the closed proportional valve 5 via the branch 11a into the branch 11b and acts upon the tubular piston 6. The tubular piston 6 displaces the regulating slide 7 against the force of the return spring 16 to the impeller 2. The cylindrical section 7a of the regulating slide 7 is thus increasingly axially overlapped with the impeller 2, whereby an effective flow region of the impeller 2 is radially covered by the cylindrical section 7a of the regulating slide 7.

When the regulating slide 7 is in a “closed position”, the cylindrical section 7a completely covers the impeller 2 so that, without consideration of the pump rotation speed, a minimum delivered volume flow is produced by the regulating slide 7 by full shielding of a flow-effective region of the impeller 2.

A path sensor 9 for detection of a position of the regulating slide 7 is used along a displacement path of the tubular piston 6. A contactless and non-sensitive construction is produced using a Hall sensor and a magnetic sensing element which is connected to the tubular piston 6. In order to maintain a position of the regulating slide 7, the pressure in the hydraulic control loop 11 is controlled by pulse width modulation in order to open and close the proportional valve 5 in such a way that an equilibrium between the hydraulic pressure and the pressure of the return spring 16 is achieved and maintained when the tubular piston 6 or the regulating slide 7 is in a position which corresponds to a preset position. The actual position of the regulating slide 7 is again detected by the path sensor 9 and fed back to the position adjusting means.

On the one hand, as described above, a volume flow of the coolant delivered by the coolant pump is dependent on the flow effectiveness of the impeller 5, which decreases upon increasing axial displacement of the tubular piston 6 with the regulating slide 7 in the direction of the “closed position” with an increasing degree of covering by the cylindrical section 7a of the regulating slide 7 around the impeller 2.

On the other hand, the delivered volume flow of the coolant pump is dependent on the pump rotation speed. The pump rotation speed is forcibly set by means of the belt drive by the speed of the combustion engine and includes the fluctuations characteristic of vehicle operation.

As the illustration of FIG. 2 shows, the axial piston pump 4 is arranged parallel to the pump shaft 3. A piston 40, in which a suction inlet of the axial piston pump 4 is formed, is actuated via a sliding shoe 42 which slides on a filter disk 24. The filter disk 24 rotates jointly with the impeller 2, i.e. it is arranged for conjoint rotation with respect to the pump shaft 3, and the filter disk 24 is arranged inclined with respect to a cross-sectional plane of the impeller 2, i.e. it is inclined with respect to a vertical plane of the pump shaft. As a result, in the case of a constant inclination angle of the filter disk 24, an axial spacing between the filter disk 24 and the axial piston pump 4 changes during a rotation of the pump shaft 3 between a minimum and a maximum axial spacing. The filter disk 24 is formed as an annular screen or more precisely as a ring with a filter section in the form of a screen-like filter structure, and with a small thickness of 1 mm or less. The sliding shoe 42 of the axial piston pump 4 slides on a running surface of the filter disk 24 and effects a reciprocal stroke movement on the piston 40 of the axial piston pump 4 which is orientated parallel to the pump shaft 3.

The axial piston pump 4 sucks coolant from the pump chamber 10 between a rear face of the impeller 2 and the filter disk 24. During a stroke procedure from the minimum to the maximum axial spacing between the filter disk 24 and the axial piston pump 4, the coolant is sucked in through the filter disk 24, through the sliding shoe 42 and through a suction inlet in the piston 40 into the axial piston pump 4. During a stroke procedure from the maximum to the minimum axial spacing between the filter disk 24 and the axial piston pump 4, the sucked-in coolant is pressurised and ejected through a pressure valve or ball valve into a hydraulic control loop 11 formed in the pump housing 1. In this way, the hydraulic pressure is built up in order to adjust the regulating slide 7 in the hydraulic control loop 11.

The sliding shoe 42 extends in a bell shape between a at the end of the piston 40 of the axial piston pump 4 and the filter disk 24. The sliding shoe 42 is attached to the piston 40 so as to incline flexibly around the inlet aperture in order to be able to follow a change in inclination of the sliding contact with respect to the rotating, inclined filter disk 24. An annular dynamic sealing gap is formed at the sliding contact between the rotating filter disk 24 and the bell-shaped sliding shoe 42, this sealing gap being acted upon by a compression spring of the axial piston pump 4. The filter disk 24 has a filter structure in a rotation angle region of the running surface which the sliding shoe 42 passes through during the stroke procedure from the minimum to the maximum axial spacing between the filter disk 24 and the axial piston pump 4. The screen-like filter structure is formed by a multitude of holes with a size of 80 to 300 μm, with an average or mean diameter of 100 μm, or with a uniform diameter of 100 μm. Through the filter structure of the filter disk 24, particulate impurities in the coolant are kept away from the axial piston pump 4 so that they cannot enter the hydraulic control loop 11 and cannot impair the functional capability and sealing tightness of the axial piston pump 4, of the proportional valve 5 or of the tubular piston 6. A high level of planarity is required for the running surface of the filter disk 24 in order to achieve all-around sealing of the sliding shoe 42 along the annular dynamic sealing gap on the filter disk 24, and to minimise leakage in the suction flow of the axial piston pump 4.

In a first embodiment of the invention, the filter disk 24 is made of silicon nitride (Si₃N₄) which is first sintered and then faced. The holes in the filter structure are cut or laser-drilled out of the filter disk 24 by a laser pulsed in femtoseconds. Burrs at the cut or drilled holes are then removed and smoothed by mechanical grinding and/or polishing.

The filter disk 24 is inserted and fastened on the rear face of the impeller 2 by means of a fitting member 22. The fitting member 22 is formed as a component of a cast body of the impeller 2 and provides receiving points which specify an inclination of the inserted filter disk 24 with respect to a cross-sectional plane of the impeller 2 or a perpendicular plane with respect to the pump shaft 3.

The filter disk 24 made of silicon nitride has ceramic material properties, such as in particular a high level of stiffness, so that original planarity of the filter disk 2 is retained even after insertion into the inclined position along the receiving points on the rear face of the impeller. Planarity of the filter disk 24 made of silicon nitride is thus also dimensionally stable with respect to the effects of forces such as a pressure required for insertion during mounting of the filter disk 24 on the impeller 2, or a pressure of the sliding shoe 42 against the running surface of the filter disk 24. Owing to the ceramic hardness of the silicon nitride, metal particles do not cause any micro-scratches on the running surface of the filter disk 24. Such particles can, if they are small, pass through the filter structure in the suction direction, or once attached to the surface of the filter disk 24, come in a rotational motion into the sliding contact between the sliding shoe 42 and the filter disk 24. By the avoidance of micro-scratches in the running surface a sealing property is unvaryingly retained at the dynamic annular sealing gap and a coefficient of friction remains constant between the sliding shoe 42 and filter disk 24 over a long period of time.

In a second embodiment of the invention the sliding shoe 42 also consists of silicon nitride (Si₃N₄). Therefore, a friction pairing of the same material is created which has the same wear properties on both sides. Therefore, formation of micro-scratches by metal particles can also be avoided on the annular sealing surface of the sliding shoe 42. Therefore, it is possible to prevent long-term impairment of the dynamic annular sealing gap, i.e. a property of sealing against leakage on the intake side of the axial piston pump 4 can be kept constant over a long period of time.

In alternative embodiments, the filter disk 24 and the sliding shoe 42 can be produced from a ceramic material, the main component of which is formed by silicon nitride, or they can consist of one or a number of other ceramic materials. Such ceramic materials can contain oxide ceramics such as aluminium oxide, magnesium oxide or zirconium oxide, or non-oxide ceramics such as carbides (e.g. silicon carbide), other nitrides (e.g. aluminium nitride), or the like.

### LIST OF REFERENCE NUMERALS

1 pump housing

2 impeller

3 pump shaft

4 axial piston pump

5 proportional valve

6 tubular piston

7 regulating slide

7a cylindrical section of the regulating slide

7b rear wall section of the regulating slide

8 belt pulley

9 path sensor

10 pump chamber

11 hydraulic control loop

11a branch of the hydraulic control loop

11b branch of the hydraulic control loop

16 return spring

17 sealing lip

24 filter disk

22 fitting member

40 piston with suction inlet

42 sliding shoe

1. An adjustable coolant pump for delivering a coolant for a combustion engine, comprising
a pump housing having a pump chamber connected to an inlet and an outlet of the pump housing; and an impeller rotatably accommodated in the pump chamber on a pump shaft mechanically driven by the combustion engine;
wherein
a delivery flow of the coolant is limitable by a regulating slide in that a cylindrical section of the regulating slide is axially slidable inside the pump chamber to radially shield the impeller; and the regulating slide is actuated by a hydraulic actuator in a hydraulic control loop, the hydraulic control loop being fed with the coolant from the delivery flow and including an axial piston pump as well as a proportional valve for generating and adjusting a pressure on the hydraulic actuator;
a sliding shoe arranged at an intake side of the axial piston pump and surrounding an inlet of the axial piston pump; and
a filter disk for filtering the coolant prior to entry into the hydraulic control loop, wherein the filter disk is arranged for conjoint rotation with respect to the pump shaft and inclined to a cross-sectional plane of the impeller, and the filter disk is in a sliding contact with the sliding shoe, so that coolant is sucked in from the pump chamber through the filter disk and the sliding shoe into the axial piston pump while a rotational motion of the filter disk is transformed into a stroke motion of the axial piston pump;
wherein
the filter disk consists of a ceramic material.

2. (canceled)

3. The adjustable coolant pump according to claim 1, wherein the ceramic material consists of silicon nitride (Si₃N₄) or contains the same as a main component.

4. A filter disk for use in an adjustable coolant pump for delivering a coolant for a combustion engine, the adjustable coolant pump comprising:
a pump housing having a pump chamber connected to an inlet and an outlet of the pump housing, and an impeller rotatably accommodated in the pump chamber on a pump shaft mechanically driven by the combustion engine;
wherein
a delivery flow of the coolant is limitable by a regulating slide in that a cylindrical section of the regulating slide is axially slidable inside the pump chamber to radially shield the impeller, and the regulating slide is actuated by a hydraulic actuator in a hydraulic control loop, wherein the hydraulic control loop is fed with the coolant from the delivery flow and includes an axial piston pump as well as a valve for generating and adjusting a pressure on the hydraulic actuator, and a sliding shoe that surrounds an inlet of the axial piston pump is arranged at an intake side of the axial piston pump; wherein
the filter disk in the adjustable coolant pump filters coolant prior to entry into the hydraulic control loop, the filter disk is arranged for conjoint rotation with respect to the pump shaft and inclined to a cross-sectional plane of the impeller, and the filter disk is in sliding contact with the sliding shoe, so that coolant is sucked in from the pump chamber through the filter disk and the sliding shoe into the axial piston pump while a rotational motion of the filter disk is transformed into a stroke motion of the axial piston pump;
wherein
the filter disk consists of a ceramic material.

5. The filter disk for use in an adjustable coolant pump according to claim 4, wherein
the ceramic material consists of silicon nitride (Si₃N₄) or contains the same as a main component.

6. A method for producing a filter disk according to claim 4 comprising the steps:
providing a circular disk sintered from a ceramic material; and
producing a filter structure having a multitude of openings through a thickness direction of the circular disk;
wherein
the multitude of openings with an average diameter of 80-300 μm is cut or drilled in the ceramic material of the circular disk by a laser with a light pulse duration set in the femtosecond range.

7. The method for producing a filter disk according to claim 6, wherein
the multitude of openings is produced with differentlor uniformly sized circular diameters by means of laser drilling.

8. The method for producing a filter disk according to claim 6, wherein
the multitude of openings has a uniform diameter of 100 μm.

9. The method for producing a filter disk according to claim 6, furthermore comprising the step:
mechanical smoothing of a surface of the filter structure on the circular disk.

10. A method for producing a filter disk according to claim 5 comprising the steps:
providing a circular disk sintered from a ceramic material; and
producing a filter structure having a multitude of openings through a thickness direction of the circular disk;
wherein
the multitude of openings with an average diameter of 80-300 μm is cut or drilled in the ceramic material of the circular disk by a laser with a light pulse duration set in the femtosecond range.

11. The method for producing a filter disk according to claim 10, wherein
the multitude of openings is produced with differently or uniformly sized circular diameters by means of laser drilling.

12. The method for producing a filter disk according to claim 7, wherein
the multitude of openings has a uniform diameter of 100 μm.

13. The method for producing a filter disk according to claim 10, wherein
the multitude of openings has a uniform diameter of 100 μm.

14. The method for producing a filter disk according to claim 11, wherein
the multitude of openings has a uniform diameter of 100 μm.

15. The method for producing a filter disk according to claim 7, furthermore comprising the step:
mechanical smoothing of a surface of the filter structure on the circular disk.

16. The method for producing a filter disk according to claim 8, furthermore comprising the step:
mechanical smoothing of a surface of the filter structure on the circular disk.

17. The method for producing a filter disk according to claim 10, furthermore comprising the step:
mechanical smoothing of a surface of the filter structure on the circular disk.

18. The method for producing a filter disk according to claim 11, furthermore comprising the step:
mechanical smoothing of a surface of the filter structure on the circular disk.

19. The method for producing a filter disk according to claim 12, furthermore comprising the step:
mechanical smoothing of a surface of the filter structure on the circular disk.

20. The method for producing a filter disk according to claim 13, furthermore comprising the step:
mechanical smoothing of a surface of the filter structure on the circular disk.

21. The method for producing a filter disk according to claim 14, furthermore comprising the step:
mechanical smoothing of a surface of the filter structure on the circular disk.
